(19) United States
(12) Patent Application Publication
(10) Pub. No.: US 2006/0262883 A1
(43) Pub. Date: Nov. 23, 2006

(54) Method and apparatus for estimating Doppler speed in wireless communication

(75) Inventors: Bin Li, Ronkonkoma, NY (US); Alexander Reznik, Titusville, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/173,026

(22) Filed: Jul. 1, 2005

Related U.S. Application Data
(60) Provisional application No. 60/678,644, filed on May 6, 2005.

(51) Int. Cl. H04L 27/00

(52) U.S. Cl. 375/316

(57) ABSTRACT

The present invention is related to a method and apparatus for estimating Doppler speed in wireless communication. The apparatus comprises a receiver, a sampler, a pilot/data removal unit, a phase change rate (PCR) measurement unit, a Doppler speed value calculating unit. The receiver receives signals, and the sampler samples the received signals. The pilot/data removal unit removes pilot or data information from the samples. The PCR measurement unit measures a PCR of the samples and the Doppler speed value calculating unit calculates a Doppler speed value based on the PCR. The Doppler speed value calculating unit is preferably a look-up table or a mapping functional unit.

### CROSS REFERENCE TO RELATED APPLICATION

This application claims the benefit of U.S. provisional application No. 60/678,644 filed May 6, 2005, which is incorporated by reference as if fully set forth.

### FIELD OF INVENTION

The present invention is related to wireless communication systems. More particularly, the present invention is related to a method and apparatus for estimating Doppler speed in wireless communication.

### BACKGROUND

In a wireless communication system, transmitted signals typically suffer Doppler spread and fading. The Doppler spread is due to the mobility of a transmitter and a receiver. In order to achieve the optimal receiver performance, the receiver needs to estimate this unknown Doppler spread or Doppler speed parameter. However, it is very complicated to estimate the Doppler speed. Therefore, it is desirable to provide a simple method and apparatus to estimate the Doppler speed parameter.

Prior art Doppler speed estimation techniques are very complex and are usually not suitable for implementations where complexity reduction is important, such as wireless transmit/receive units (WTRUs). Therefore, there exists a need for efficient Doppler speed estimation.

### SUMMARY

The present invention is related to a method and apparatus for estimating Doppler speed in wireless communications. The apparatus comprises a receiver, a sampler, a pilot/data removal unit, a phase change rate (PCR) measurement unit, a Doppler speed value calculating unit. The receiver receives signals, and the sampler samples the received signals. The pilot/data removal unit removes pilot or data information from the samples. The PCR measurement unit measures a PCR of the samples and the Doppler speed value calculating unit calculates a Doppler speed value based on the PCR. The Doppler speed value calculating unit is preferably a look-up table, or a mapping functional unit.

### BRIEF DESCRIPTION OF THE DRAWING

FIG. 1 is a flow diagram of a process for estimating Doppler speed in accordance with the present invention.

FIG. 2 is a block diagram of an apparatus for estimating Doppler speed in accordance with the present invention.

FIG. 3 is a diagram of simulation results for estimating Doppler speed using the apparatus of FIG. 1.

### DETAILED DESCRIPTION OF THE PREFERRED EMBODIMENTS

The features of the present invention may be incorporated into an integrated circuit (IC) or be configured in a circuit comprising a multitude of interconnecting components.

The present invention provides a simple method and apparatus to estimate Doppler speed. The present invention provides a good estimation of Doppler speed to achieve improved receiver performance. In accordance with the present invention, a phase change rate (PCR) between two symbols is measured and the measured PCR is mapped to a Doppler speed value according to a predetermined mapping table or a mapping curve.

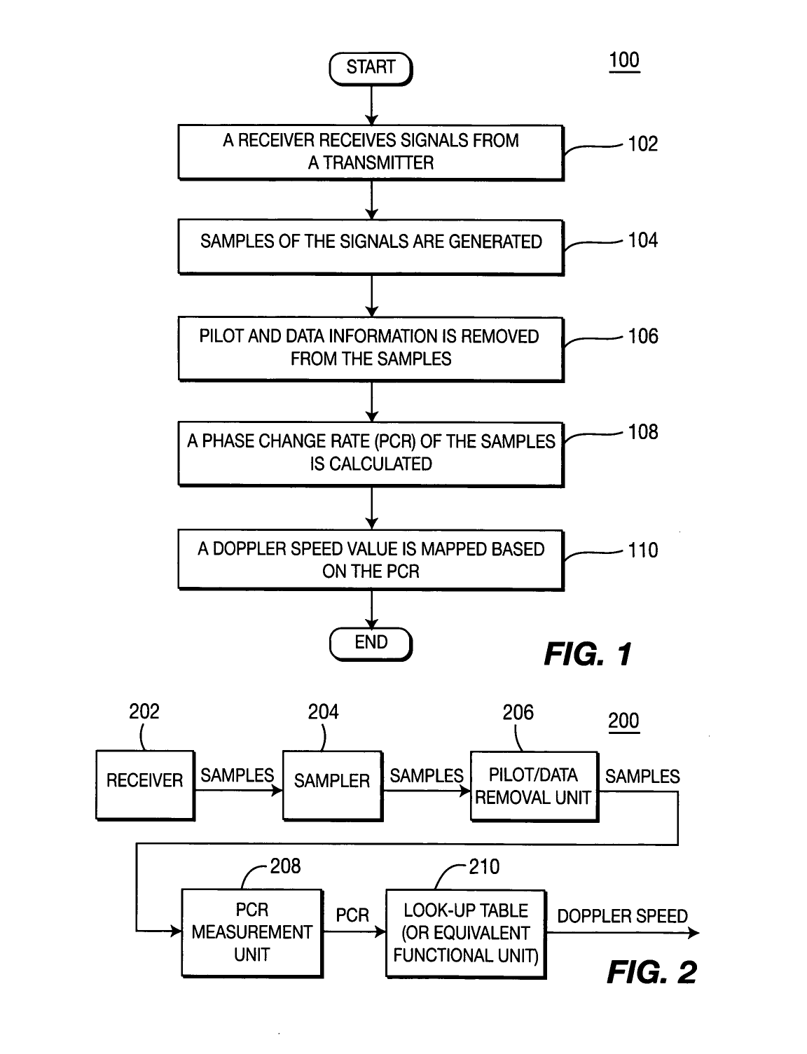

FIG. 1 is a flow diagram of a process 100 for estimating Doppler speed in accordance with the present invention. For the purpose of present explanation, it is assumed that the fading is Rayleigh flat fading, although this is not required. Other assumptions may be utilized with the present invention while introducing a bias to take into account the particularities of those assumptions. Transmitted signals are received by a receiver (step 102). The received signals are then sampled (step 104).

The transmitted signals can be pilot signals containing known pilot information or data transmissions containing traffic data. If the received signal samples are pilot symbols, the pilot information is removed from the received signal samples.

If the received signal samples are data symbols, the data information is removed from the received signal samples (step 106). The data information may be removed using any known prior art method, such as a decision-feedback method. Accordingly, it can be assumed that the samples are pure samples of the transmission fading channel and do not contain any transmitted information.

The higher the Doppler speed is, the bigger the PCR is between any two samples. Therefore, the PCR between two samples is calculated (step 108). The calculated PCR is then mapped to a Doppler speed using a lookup table or a mapping function (step 110).

The Doppler speed estimation method is explained in detail hereinafter. The received N signal samples, after removing pilot or data information, are v₁, v₂, . . . , v_{N}, which can be expressed as follows:
vₖ=gₖ+nₖ; Equation (1)
where gₖ is the channel gain that is Doppler spread Rayleigh fading, and nₖ is the additive Gaussian white noise sample.

It is determined whether the probability of the phase change between two samples, (i.e., PCR), separated by m samples (m is predetermined) is within a predetermined range as follows:
P=Pr└|phase(vₖ₊ₘvₖ*)|≦θ₀┘. Equation (2)

The probability in equation (2) can be calculated as follows:

$$P = \frac{1}{N} {\sum }_{k = 1}^{N} Q [ \vert phase ( {v}_{k + m} {v}_{k}^{*} ) \vert \leq {θ}_{0} ] ; \qquad Equation ( 3 )$$

where N is the number of samples used for calculation. Q└|phase(vₖ₊ₘvₖ*)|≦θ₀┘=1, if |phase(vₖ₊ₘvₖ*)|≦θ₀, otherwise Q└|phase(vₖ₊ₘvₖ*)|≦θ₀┘=0.

A simple example of the Doppler speed estimator is to choose θ₀=90°. Therefore, the condition detection of |phase(vₖ₊ₘvₖ*)|≦θ₀ becomes a simple condition detection of Re└vₖ₊ₘvₖ*┘≧0, where Re(x) is the real part of complex number x. The probability can be rewritten as follows:

$$P = \frac{1}{N} {\sum }_{k = 1}^{N} Q [ Re ( {v}_{k + m} {v}_{k}^{*} ) ] ; \qquad Equation ( 4 )$$

where Q(x)=1, if x>0, and Q(x)=0, if x<0.

FIG. 2 is a block diagram of an apparatus for estimating Doppler speed in accordance with the present invention. The apparatus 200 comprises a receiver 202, a sampler 204, a pilot/data removal unit 206, a PCR measurement unit 208 and a look-up table 210, (or equivalent functional unit). The receiver 202 receives signals and the received signals are sampled by the sampler 204. The pilot/data removal unit 206 receives samples generated by the sampler 204 and removes pilot or data information from the samples. The samples are then forwarded to the PCR measurement unit 208 which measures a PCR in the samples. The PCR value from the PCR measurement unit 208 is forwarded to the look-up table 210 (or equivalent functional unit) to be mapped to a Doppler speed value.

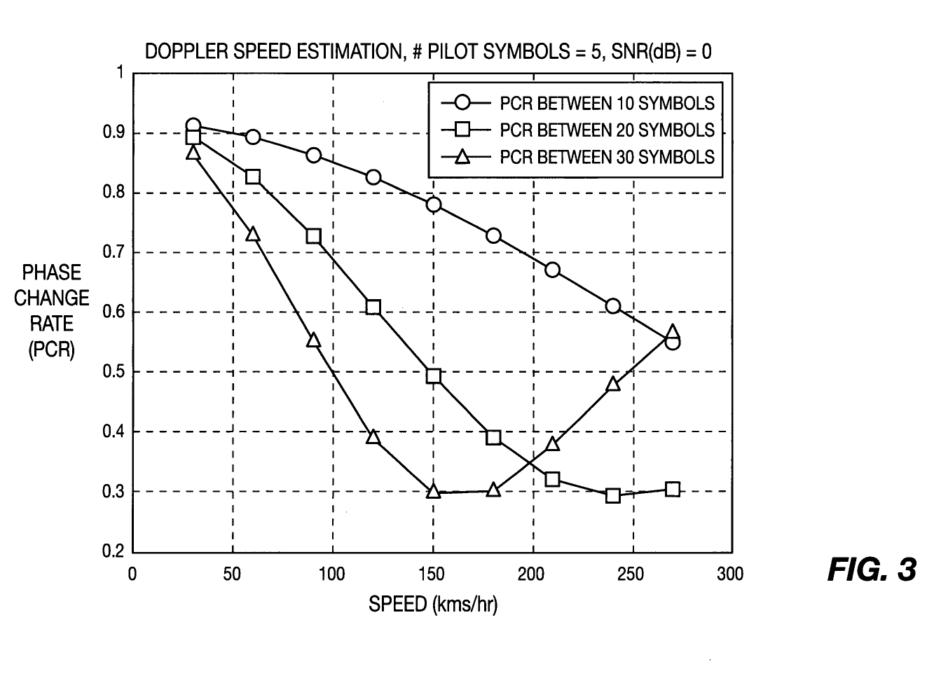

The look-up table is the simple and commonly used approach. Alternatively, a mathematical expression of the curve in FIG. 3, (i.e., speed=function(PCR)), can be used to calculate the speed according to the input PCR.

FIG. 3 is a diagram of simulation results using the method of FIG. 1 in accordance with the present invention. FIG. 3 shows the relationship between the Doppler speed value and the probability of phase change in equation (4), i.e., a PCR. The symbol rate is 15 kHz in the simulation. Of course, those of skill in the art would realize that this symbol rate is just an example. Two symbols for phase change rate calculation are separated by 10 symbols (m=10), 20 symbols (m=20) and 30 symbols (m=30), respectively. The signal-to-noise ratio (SNR) is 0 dB. For each m, a different curve is achieved. For each curve, the measured PCR value can be used to obtain a Doppler speed value as a Doppler estimate. The parameter “m” is a design parameter. For small m, such as m=10, the Doppler speed estimate can be larger than 250 km/hr, but the resolution is low. For large m, such as m=30, the Doppler speed estimate can be limited to 150 km/hr but the resolution is high.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A method for estimating Doppler speed in wireless communications, the method comprising:
receiving signals;
generating samples of the signals;
calculating a phase change rate (PCR) of the samples; and
calculating a Doppler speed value from the PCR.

2. The method of claim 1 wherein said calculating step uses a look-up table.

3. The method of claim 1 further comprising a step of removing pilot and data information from the samples.

4. The method of claim 1 wherein the Doppler speed value is calculated by using a mapping function.

5. The method of claim 1 wherein two samples separated by a predetermined number of samples are measured to calculate the PCR.

6. The method of claim 1 wherein the PCR is calculated by measuring a probability of phase change between two samples separated by a predetermined number of samples within a predetermined range.

7. The method of claim 6 wherein the predetermined range is 90 degrees.

8. An apparatus for estimating Doppler speed in wireless communications, the apparatus comprising:
a receiver for receiving signals;
a sampler for generating samples of the received signals;
a phase change rate (PCR) measurement unit for measuring PCR of the samples; and
a Doppler speed value calculation unit for calculating a Doppler speed value from the PCR.

9. The apparatus of claim 8 wherein the Doppler speed value calculating unit comprises a look-up table.

10. The apparatus of claim 8 further comprising a pilot/data removal unit for removing pilot or data information from the samples.

11. The apparatus of claim 8 wherein the Doppler speed value calculating unit comprises a mapping functional unit.

12. The apparatus of claim 8 wherein two samples separated by a predetermined number of samples are measured to calculate the PCR.

13. The apparatus of claim 8 wherein the PCR is calculated by measuring a probability of phase change between two samples separated by a predetermined number of samples within a predetermined range.

14. The apparatus of claim 13 wherein the predetermined range is 90 degrees.
